(19) United States
(12) Patent Application Publication
(10) Pub. No.: US 2021/0090057 A1
(43) Pub. Date: Mar. 25, 2021

(54) STORE MANAGEMENT DEVICE, STORE MANAGEMENT SYSTEM, AND STORE MANAGEMENT METHOD

(71) Applicant: TOSHIBA TEC KABUSHIKI KAISHA, Tokyo (JP)

(72) Inventor: Yuishi TAKENO, Numazu Shizuoka (JP)

(73) Assignee: TOSHIBA TEC KABUSHIKI KAISHA, Tokyo (JP)

(21) Appl. No.: 16/924,688

(22) Filed: Jul. 9, 2020

(30) Foreign Application Priority Data
Sep. 24, 2019 (JP) 2019-173506

(51) Int. Cl. G06Q 20/20; G06Q 20/38; G06Q 20/40; G08B 27/00

(52) U.S. Cl. CPC G06Q 20/208; G06Q 20/203; G08B 27/00; G06Q 20/401; G06Q 20/382

(57) ABSTRACT

A store management system includes an interface and a processor. The interface is configured to facilitate acquiring information visiting plurality of customers who enter a store. The processor is configured to identify each customer of the plurality of customers based on the information acquired through the interface, group a subset of the plurality of customers into a customer group based on the information, and settle a single commodity list of commodities intended to be purchased by the customer group in a single settlement transaction.

### CROSS-REFERENCE TO RELATED APPLICATION

This application is based upon and claims the benefit of priority from Japanese Patent Application No. 2019-173506, filed Sep. 24, 2019, the entire contents of which are incorporated herein by reference.

### FIELD

Embodiments described herein relate generally to a store management device that performs settlement in a commodity sales store.

### BACKGROUND

In a commodity sales store and the like, there has been conceived a system that tracks intra-store actions of a store visiting customer with cameras, sensors, and the like and allows the store visiting customer to operate a settlement terminal and perform settlement for commodity purchase by himself or herself.

In the system in which the store visiting customer performs settlement by himself or herself, it can be expected that labor on a store side is saved and shoplifting of commodities is prevented.

However, the system for saving labor explained above does not assume that a plurality of people such as a family or friends visit the store. Accordingly, store visiting customers need to perform settlement using one shopping basket or each of the store visiting customers needs to perform settlement. Therefore, the settlement is congested or a large number of settlement terminals need to be prepared.

Related art is described in, for example, WO2017/150590.

### DESCRIPTION OF THE DRAWINGS

FIG. 1 is a schematic diagram illustrating an example of a configuration of a store management device according to an embodiment;

FIG. 2 is a diagram illustrating a layout example in a store into which the store management device is introduced;

FIG. 3 is a diagram illustrating an example of a store visiting customer list managed by the store management device;

FIG. 4 is a diagram illustrating an example of a group list managed by the store management device;

FIG. 5 is a flowchart of a method for store entry processing performed by the store management device;

FIG. 6 is a flowchart of a method for grouping processing performed by the store management device;

FIG. 7 is a diagram illustrating an example of a store visiting customer list managed by the store management device;

FIG. 8 is a diagram illustrating an example of a group list managed by the store management device;

FIG. 9 is a flowchart of a method for intra-store processing performed by the store management device;

FIG. 10 is a flowchart of a method for settlement processing performed by the store management device; and

FIG. 11 is a flowchart of a method for store leaving processing performed by the store management device.

### DETAILED DESCRIPTION

An object of the present disclosure is to provide a store management device, a store management system, and a store management method for enabling a store visiting customer to efficiently perform settlement.

A store management device according to an embodiment includes an interface and a processor. The interface acquires information concerning store visiting customers who enter a store. The processor identifies the store visiting customers based on the information acquired through the interface, groups the identified store visiting customers, and settles, for each of groups, commodities purchased by the grouped store visiting customers.

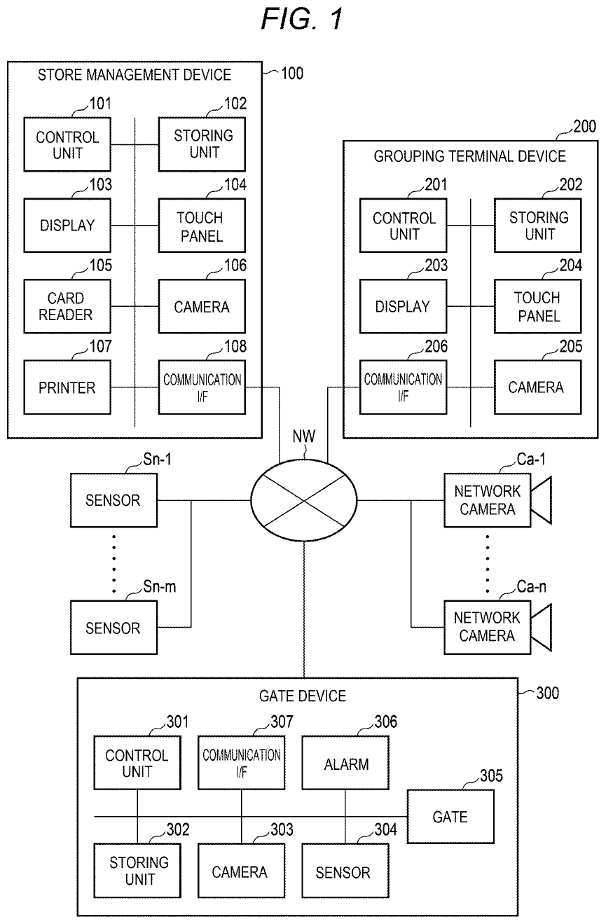

A store management device according to an embodiment is explained below with reference to the drawings. FIG. 1 is a diagram illustrating a system configuration of a store into which the store management device is introduced. A store management device 100, a grouping terminal device 200, a gate device 300, network cameras Ca-1 to Ca-n, and sensors Sn-1 to Sn-m are connected to one another via a communication network NW such as a wired local area network (LAN) or a wireless LAN.

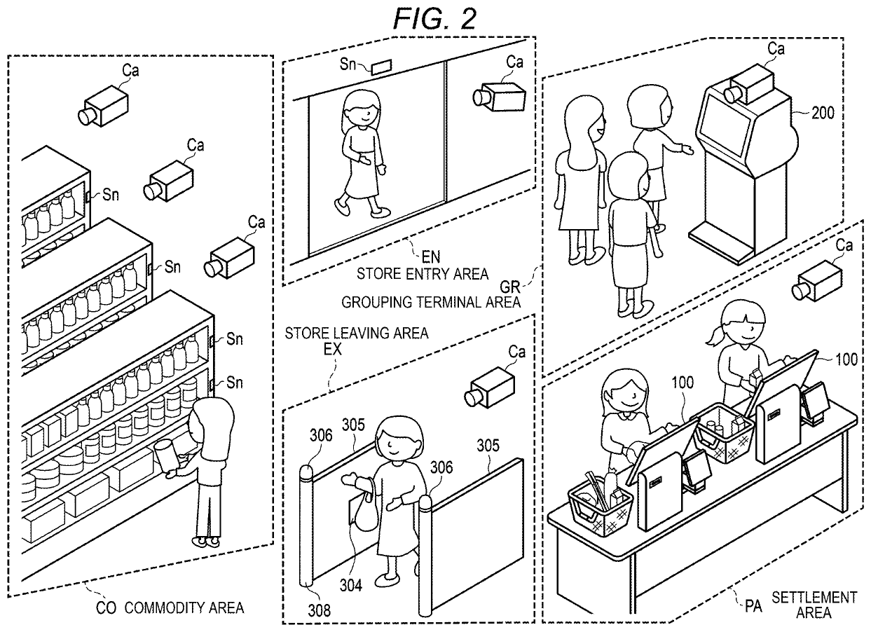

FIG. 2 is a diagram illustrating a layout example in the store into which the store management device is introduced. As illustrated in this example, the store management device 100 is set in a settlement area PA. The grouping terminal device 200 is set as a grouping terminal area GR close to a store entry area EN, which is an entrance of the store. The gate device 300 is set in a store leaving area EX near a store exit. Also, a commodity area CO where display shelves, on which commodities are displayed, are disposed is present in the store. In the example illustrated in FIG. 2, the store entry area EN and the store leaving area EX are separately provided. However, it is also possible to set the store entry area EN and the store leaving area EX in the same gateway of the store.

### Store Management Device

The store management device 100 is configured to provide a store visiting customer tracking function for tracking intra-store actions of a store visiting customer and various processing functions. The store management device 100 includes a control unit 101 (a controller, a supervisory controller, etc.), a storing unit 102 (a memory), a display 103, a touch panel 104 (a user interface), a card reader 105, a camera 106, a printer 107, and a communication interface (I/F) 108.

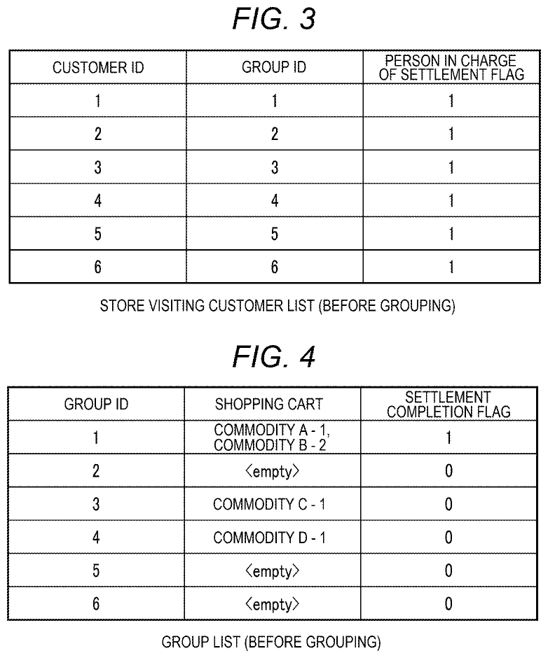

The storing unit 102 stores a control program and control data for the control unit 101. The storing unit 102 may be or include a hard drive disk (HDD), a flash memory, or the like. As examples of the control data, there are a store visiting customer list illustrated in FIG. 3 and a group list illustrated in FIG. 4. The store visiting customer list is a data table for managing, for each of store visiting customers, a group for settlement and a person in charge of settlement. The group list is a data table for managing, for each of the groups, settlement and non-settlement of commodities put in a shopping cart. These lists are updated by the control unit 101.

The display 103 shows various kinds of information to operators such as a store visiting customer and a store related person. A sensor is provided on a display surface of the display 103. The touch panel 104 receives an input by the operator through the sensor.

The card reader 105 performs readout of information from and writing of information in, for example, a non-contact integrated circuit (IC) card and a magnetic card. For example, the card reader 105 is capable of communicating with a credit card, a debit card, various electronic money cards, a smartphone-incorporated noncontact IC chip, etc. used by store visiting customers.

The camera 106 images, for example, an operator standing in front of the store management device 100. The printer 107 prints and outputs a receipt and the like.

The communication interface 108 is a communication interface such as a LAN. The communication interface 108 is capable of communicating with the various devices illustrated in FIG. 1 and devices on the outside of the store via the network NW.

The control unit 101 includes a processor or processing circuit and collectively controls the units of the store management device 100 according to the control program and the control data stored in the storing unit 102. The control unit 101 performs, as functions realized by the control, at least the store visiting customer tracking function explained above and other various processing functions (store entry processing, grouping processing, intra-store processing, settlement processing, and store leaving processing).

The store visiting customer tracking function identifies/distinguishes a store visiting customer and individually tracks intra-store actions based on videos captured by the network cameras Ca-1 to Ca-n and detects, based on an analysis of the videos and information from the sensors Sn-1 to Sn-m, that the store visiting customer takes out a commodity from a display shelf.

As a method of identifying/distinguishing a store visiting customer, there is a method of recognizing the face of the store visiting customer. This method may be adopted. However, the method of distinguishing a store visiting customer is not limited to this. The control unit 101 issues an individual ID to the store visiting customer based on the videos captured by the network cameras Ca-1 to Ca-n and tracks movement in the store of the store visiting customer based on the videos. That is, the control unit 101 manages, with the ID, the position of the store visiting customer.

The network cameras Ca-1 to Ca-n are set considering a photographing layout of the cameras such that intra-store actions of the store visiting customer can be tracked. For example, the network cameras Ca-1 to Ca-n are set considering the photographing layout such that videos overlap among the cameras or set such that imaging can be performed to cover the entire region in the store without causing blind spots in the store. Besides, if intra-store actions of the store visiting customer can be tracked, it is also conceivable to set the network cameras Ca-1 to Ca-n to be able to photograph only the store entry area EN, the commodity area CO, and the store leaving area EX.

The sensors Sn-1 to Sn-m are provided in display shelves on which commodities are displayed. The sensors Sn-1 to Sn-m detect that commodities are taken out from and returned to the display shelves. As a type of the sensors, various sensors such as an infrared sensor, a weight sensor, and a magnetic sensor are applicable. The sensors Sn-1 to Sn-m identify and detect take-out of various commodities displayed on the display shelves. The sensors Sn-1 to Sn-m may read identification tags or barcodes provided in the commodities to identify the take-out and the return. Concerning the setting of the sensors Sn-1 to Sn-m, various setting methods are conceivable. However, an existing technique can be applied as appropriate.

In all the setting methods, disposition information of the network cameras Ca-1 to Ca-n and the sensors Sn-1 to Sn-m is stored in the storing unit 102. The control unit 101 tracks, based on the disposition information, intra-store actions of the store visiting customer including take-out of commodities.

To enable parallel settlement processing for a plurality of store visiting customers, a plurality of sets of the display 103, the touch panel 104, the card reader 105, the camera 106, and the printer 107 may be provided. The control unit 101 may control the respective sets.

### Grouping Terminal Device

The grouping terminal device 200 is a human-machine interface for receiving a request for grouping from a store-visiting customer. The grouping terminal device 200 includes a control unit 201 (a controller), a storing unit 202 (a memory), a display 203, a touch panel 204 (a user interface), a camera 205, and a communication interface (I/F) 206.

The storing unit 202 stores a control program and control data for the control unit 201. The storing unit 202 may be or include a HDD or a flash memory. The display 203 shows various kinds of information to operators such as a store visiting customer and a store related person.

A sensor is provided on a display surface of the display 203. The touch panel 204 receives an input of an operator through the sensor.

The camera 205 images an operator standing in front of the grouping terminal device 200. For example, the camera 205 is mounted with a lens positioned to enable imaging of a plurality of people standing in front of the grouping terminal device 200. The communication interface 206 is a communication interface such as a LAN. The communication interface 206 communicates mainly with the store management device 100 via the network NW.

The control unit 201 includes a processor and collectively controls the units of the grouping terminal device 200 according to the control program and the control data stored in the storing unit 202. As functions realized by the control, the control unit 201 performs at least a grouping receiving function.

The grouping receiving function provides video data photographed by the camera 205 to the store management device 100, displays information provided from the store management device 100 on the display 203, receives, from a store visiting customer, a request for grouping a plurality of store visiting customers, and provides the received information to the store management device 100. That is, the grouping receiving function receives a request for grouping a plurality of customers who visit the store together as a group.

### Gate Device

The gate device 300 is a gate that limits store leaving of a store visiting customer. The gate device 300 includes a control unit 301 (a controller), a storing unit 302 (a memory), a camera 303, a sensor 304, a gate 305, an alarm 306, and a communication interface (I/F) 307.

The storing unit 302 stores a control program and control data for the control unit 301. The storing unit 302 may be or include a HDD or a flash memory. The camera 303 images a store visiting customer who is about to leave the store through the gate 305. The sensor 304 detects that a store visiting customer enters through the gate 305.

The gate 305 is a passage that guides a store visiting customer after settlement from the inside to the outside of the store. The passage includes, for example, two walls forming a pair. In the example illustrated in FIG. 2, a mechanism for physically preventing store leaving of a store visiting customer (e.g., a gate, a bar, etc.) is not illustrated. However, such a mechanism may be provided to allow the control unit 301 to control passage.

The alarm 306 is set, for example, at the upper end of the gate 305 and emits sound and/or light to warn a store visiting customer and prevent store leaving of a store visiting customer.

The communication interface 307 is a communication interface such as a LAN. The communication interface 307 communicates mainly with the store management device 100 via the network NW.

The control unit 301 includes a processor and collectively controls the units of the gate device 300 according to the control program and the control data stored in the storing unit 302. Specifically, the control unit 301 controls to drive the alarm 306 (and/or the gate mechanism) to limit store leaving of a storing visiting customer according to an instruction received from the store management device 100 through the network NW.

### Explanation of Operation

The operation of the system having the configuration explained above is explained. The system executes processing corresponding to actions of a store visiting customer while tracking the actions in the store of the store visiting customer with the store visiting customer tracking function explained above. That is, the system executes tracking processing by the store visiting customer tracking function. The system is capable of executing store entry processing, grouping processing, intra-store processing, settlement processing, and store leaving processing in parallel to one another. These kinds of processing are explained below in order.

### Store Entry Processing

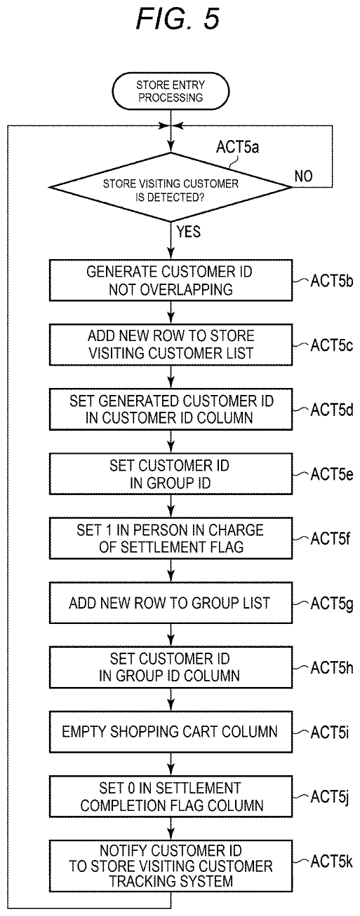

FIG. 5 is a flowchart illustrating the store entry processing. The store entry processing is processing for giving a customer ID to a store visiting customer entering the store and performs setting of a group ID and a shopping cart. The store entry processing is performed by the store management device 100. The control unit 101 executes the store entry processing according to the control program and the control data stored in the storing unit 102. The store entry processing is repeatedly executed while the system is operating.

In ACT 5a, the control unit 101 determines, based on a detection result of a sensor Sn set near the store entry area EN and video data captured by a camera Ca set near the store entry area EN, whether a customer enters the store from the store entrance. If determining that a customer enters the store, the control unit 101 shifts to ACT 5b assuming that a store visiting customer is detected. If not detecting entry of a customer, the control unit 101 continues to monitor entry of a customer in ACT 5a.

In ACT 5b, the control unit 101 generates an ID for the store visiting customer detected in ACT 5a and shifts to ACT 5c. The ID is generated not to overlap another ID that is currently active at the present point in time. In the case of a system in which a customer presents a member ID when entering a store, the member ID may be used.

In ACT 5c, the control unit 101 adds a new row to the data table of the store visiting customer list stored in the storing unit 102 and shifts to ACT 5d. In ACT 5d, the control unit 101 sets the customer ID generated in ACT 5b in a column of “customer ID” in the new row added in ACT 5c and shifts to ACT 5e.

In ACT 5e, the control unit 101 sets the customer ID generated in ACT 5b in a column of “group ID” in the new row added in ACT 5c and shifts to ACT 5f. That is, at a point in time immediately after the store entry, the same value is set in the column of “customer ID” and the column of “group ID”.

In ACT 5f, the control unit 101 sets “1”, which indicates a person in charge of settlement, in a column of “person in charge of settlement flag” in the new row added in ACT 5c and shifts to ACT 5g. That is, at the point in time immediately after the store entry, since the store visiting customer is not grouped with other store visiting customers, the control unit 101 sets the store visiting customer having the customer ID as the person in charge of settlement.

In the example of the store visiting customer list illustrated in FIG. 3, since grouping of a plurality of store visiting customers is not performed, in all rows, the same values are respectively set in the column of “customer ID” and the column of “group ID” and “1” is set for each customer ID as the person in charge of settlement flag.

In ACT 5g, the control unit 101 adds a new row to the data table of the group list stored in the storing unit 102 and shifts to ACT 5h. In ACT 5h, the control unit 101 sets, in a column of “group ID” in the new row added in ACT 5g, the same ID as the ID (the customer ID) set in “group ID” of the store visiting customer list in ACT 5e and shifts to ACT 5i.

In ACT 5i, the control unit 101 clears and empties a column of “shopping cart” in the new row added in ACT 5g and shifts to ACT 5j. In ACT 5j, the control unit 101 sets “0” indicating settlement incompletion in a column of “settlement completion flag” in the new row added in ACT 5g and shifts to ACT 5k. If a shopping cart is not empty, the control unit 101 may set “0” in the settlement completion flag.

In the example of the group list illustrated in FIG. 4, a state in which all store visiting customers are treated as independent customers is illustrated. The store visiting customers are not grouped. For example, a customer ID “6” of a customer, who just visits the store, independently belongs to a group ID “6”, a shopping cart is set to empty, and “0” indicating incompletion is set for settlement.

In ACT 5k, the control unit 101 notifies the customer ID generated in ACT 5b to the store visiting customer tracking function and shifts to ACT 5a. Consequently, the store visiting customer tracking function is capable of identifying the store visiting customer in common to the other kinds of processing using the customer ID as information for identifying the store visiting customer. After shifting to ACT 5a, the control unit 101 monitors whether a new store visiting customer appears in the store entry area EN. Thereafter, the same processing is repeated for each new store visiting customer.

### Grouping Processing

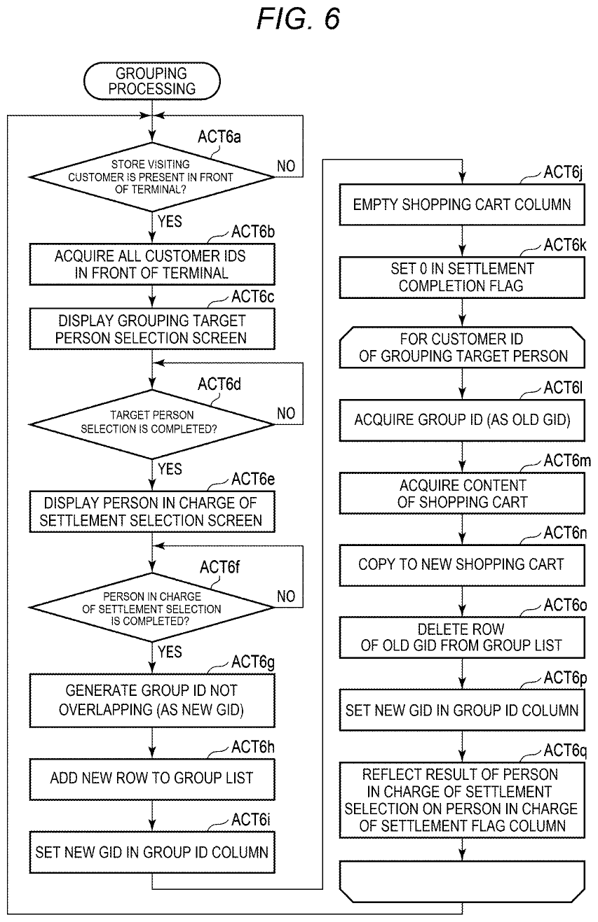

FIG. 6 is a flowchart illustrating the grouping processing. The grouping processing is processing for, in order to integrate settlement for a plurality of customers, grouping the plurality of customers into corresponding groups and causing each respective group of the group list to share the “shopping cart”. The store management device 100 performs the grouping processing in cooperation with the grouping terminal device 200. The control unit 101 executes the grouping processing according to the control program and the control data stored in the storing unit 102. The grouping processing is repeatedly executed while the system is operating.

In ACT 6a, the control unit 101 determines, based on a notification from the grouping terminal device 200, whether a store visiting customer is present in front of the grouping terminal device 200. Specifically, the control unit 201 of the grouping terminal device 200 determines, based on video data captured by the camera 205 and operation on the touch panel 204, that a store visiting customer is present in front of the grouping terminal device 200. In ACT 6a, the control unit 201 may recognize a face from the video data of the camera 205 and determine presence of a store visiting customer.

If determining that a store visiting customer is present in front of the grouping terminal device 200, the control unit 201 notifies the store management device 100 to this effect through the communication interface 206. The control unit 101, which receives the notification, shifts to ACT 6b. On the other hand, if not receiving (detecting) the notification, the control unit 101 shifts to ACT 6a again and stands by for the notification from the grouping terminal device 200.

In ACT 6b, the control unit 101 acquires, based on a tracking result of the store visiting customer tracking function, a customer ID of the store visiting customer present in front of the grouping terminal device 200 and shifts to ACT 6c. If a plurality of store visiting customers are present in the grouping terminal area GR, the control unit 101 acquires customer IDs of the store visiting customers present in the grouping terminal area GR from the tracking result of the store visiting customer tracking function.

In the case of a system in which the control unit 201 recognizes a face from the video data and determines presence of a store visiting customer in ACT 6a and the store visiting customer tracking function recognizes the face of the store visiting customer and performs tracking of the store visiting customer, the control unit 201 may notify a result of the face recognition and the video data to the control unit 101 via the network NW and the control unit 101 may specify, based on information notified from the store visiting customer tracking function, a customer ID of a store visiting customer present in front of the grouping terminal device 200.

In ACT 6c, the control unit 101 transmits the customer IDs acquired in ACT 6b to the grouping terminal device 200 (the control unit 201) via the network NW as IDs of grouping candidates (hereinafter referred to as candidate IDs) and shifts to ACT 6d. The control unit 101 then causes the control unit 201 to execute processing for causing a store visiting customer to select target store visiting customers for a group.

The control unit 201 records the received candidate IDs in the storing unit 202 and, thereafter, displays a list of the candidate IDs on the display 203. In this display, the control unit 201 also displays a message requesting that the store visiting customer present in front of the terminal selects store visiting customers for which the same settlement (the same accounting) is planned to be performed (i.e., be grouped together).

The control unit 201 receives, through the touch panel 204, designation of store visiting customers desired to be grouped and transmits customer IDs of the designated store visiting customers desired to be grouped to the store management device 100 (the control unit 101) through the network NW.

In the display in the grouping terminal device 200, the control unit 201 may correlate and display faces of the store visiting customers photographed by the camera 205 and the candidate IDs to clarify which candidate ID corresponds to which store visiting customer. In this case, this can be realized by the control unit 201 performing the face recognition, the store visiting customer tracking function of the control unit 101 performing the face recognition, and collating results of the face recognitions and correlating the faces of the store visiting customers and the candidate IDs coinciding with each other. If such correlation can be performed, it is not always necessary to display the candidate IDs. The control unit 201 only has to cause the store visiting customer to select, through the touch panel 204, faces of the store visiting customers desired to be grouped and transmit customer IDs corresponding to the faces to the control unit 101.

Even if the face recognition is not performed, the control unit 101 or the control unit 201 correlates, based on position information of store visiting customers detected by the store visiting customer tracking function, store visiting customers photographed by the camera 205 and the candidate IDs. Consequently, a desire of the store visiting customer can be accurately received.

In ACT 6d, the control unit 101 determines whether the selection of the target store visiting customers for the group is completed in the grouping terminal device 200. If the selection is completed, the control unit 101 shifts to ACT 6e. On the other hand, if the selection is not completed, the control unit 101 stays on standby in ACT 6d. Specifically, if the control unit 101 receives the notification of the customer IDs from the control unit 201, the control unit 101 determines that the selection of the target store visiting customers for the group is completed and treats the received customer IDs as one group.

In ACT 6e, the control unit 101 instructs the grouping terminal device 200 (the control unit 201) to select a person of the group to be in charge of settlement and shifts to ACT 6f. The control unit 201, which receives the instruction, displays, on the display 203, a list of the customer IDs of the store visiting customers of the group selected in ACT 6c and displays a message requesting that the store visiting customers select a respective store visiting customer of the group to be a person in charge of settlement for the group (hereinafter referred to as person in charge of settlement).

The control unit 201 receives the selection of the person in charge of settlement through the touch panel 204 and transmits the customer ID of the selected store visiting customer to the store management device 100 (the control unit 101) though the network NW.

In ACT 6f, the control unit 101 determines whether the selection of the person in charge of settlement is completed in the grouping terminal device 200. If the selection is completed, the control unit 101 shifts to ACT 6g. On the other hand, if the selection is not completed, in ACT 6f, the control unit 101 stands by for completion. Specifically, if the control unit 101 receives the notification of the customer ID from the control unit 201, the control unit 101 determines that the selection of the person in charge of settlement is completed and treats the store visiting customer having the customer ID received from the grouping terminal device 200 as the person in charge of settlement for the group.

In ACT 6g, the control unit 101 generates a new group ID for the group of customer IDs received in ACT 6d and shifts to ACT 6h. The new group ID generated is referred to as a new GID. The new GID is generated not to overlap a GID that is active at the present point in time.

In ACT 6h, the control unit 101 adds a new row to the data table of the group list stored in the storing unit 102 and shifts to ACT 6i. In ACT 6i, the control unit 101 sets the new GID generated in ACT 6g to a column of “group ID” in the new row added in ACT 6h and shifts to ACT 6j.

In ACT 6j, the control unit 101 clears a column of “shopping cart” in the new row added in ACT 6h and shifts to ACT 6k. In Act 6k, the control unit 101 sets “0” indicating settlement incompletion in a column of “settlement completion flag” in the new row added in ACT 6h and executes processing in ACTS 6l to 6q. If a shopping cart is not empty, “0” may be set in the settlement completion flag.

The processing in ACTS 6l to 6q is executed for each of the customer IDs associated with a group received in ACT 6d. That is, for example, if three customer IDs are received, the processing is executed three times for the respective group, once for each customer ID within the respective group. In ACT 6l, the control unit 101 selects one of the received customer IDs, searches through the store visiting customer list concerning the customer ID, acquires a group ID correlated with the customer ID, and shifts to ACT 6m. The acquired group ID is referred to as old GID.

In ACT 6m, the control unit 101 searches through the group list concerning the old GID acquired in ACT 6l, acquires content (information concerning commodity names and the numbers of items of the commodities) stored in the column of “shopping cart” correlated with the old GID and shifts to ACT 6n.

In ACT 6n, the control unit 101 copies (adds) the content of “shopping cart” acquired in ACT 6m to the column of “shopping cart” correlated with the new GID added to the group list in ACT 6h and shifts to ACT 6o.

In ACT 6o, the control unit 101 deletes, from the group list, the row in which the old GID is set and shifts to ACT 6p.

In ACT 6p, the control unit 101 searches through the store visiting customer list concerning the customer ID selected in ACT 6l, sets the new GID in the column of “group ID” correlated with the customer ID, and shifts to ACT 6q.

In ACT 6q, the control unit 101 searches through the store visiting customer list concerning the customer ID selected in ACT 6l, reflects the information concerning the person in charge of settlement selected in ACT 6f on the store visiting customer list, and shifts to ACT 6a. Specifically, if the customer ID selected in ACT 6l coincides with the customer ID of the person in charge of settlement notified in ACT 6f, the control unit 101 maintains a value of the column of “person in charge of settlement flag” at “1”. On the other hand, if the store visiting customer having the customer ID is not the person in charge of settlement, that is, if the customer ID selected in ACT 6l does not coincide with the customer ID of the person in charge of settlement notified in ACT 6f, the control unit 101 sets the value of the column of “person in charge of settlement flag” to “0”.

As an example, it is conceived that, in ACT 6d, the control unit 101 receives a notification of customer IDs “3”, “4”, and “6” from the control unit 201 and, in ACT 6f, the control unit 101 receives a notification of a customer ID “4” as the person in charge of settlement. It is assumed that, in a situation before these notifications are received, the store visiting customer list is as illustrated in FIG. 3 and the group list is as illustrated in FIG. 4.

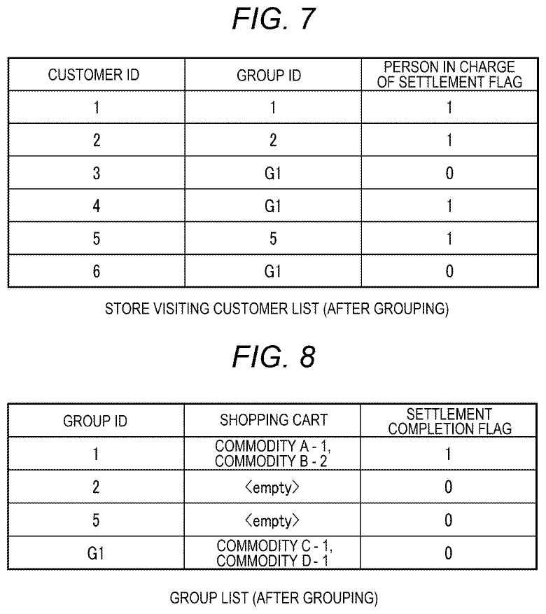

According to the notifications, the store visiting customer list changes as illustrated in FIG. 7. That is, in ACT 6p, the control unit 101 sets “G1”, which is a new GID, in columns of “group ID” of the customer IDs “3”, “4”, and “6”. In ACT 6q, the control unit 101 sets values of the column of “person in charge of settlement flag” of the customer ID “3” and “6” to “0” and maintains “1” concerning the customer ID “4”.

On the other hand, the group list changes as illustrated in FIG. 8. That is, in ACT 6h, the control unit 101 adds a new row to the data table of the group list. In ACT 6i, the control unit 101 sets “G1”, which is a new GID, in the column of “group ID” of the new row.

In ACT 6m, the control unit 101 acquires contents of the “shopping cart” corresponding to group IDs (old GIDs) in which the customer IDs “3”, “4”, and “6” are set. Subsequently, in ACT 6n, the control unit 101 copies (adds) the contents of the “shopping cart” acquired in ACT 6m to the column of “shopping cart” corresponding to “G1”, which is the new GID. In ACT 6o, the control unit 101 deletes rows of the group list corresponding to the group IDs (old GIDs) to which the customer IDs “3”, “4”, and “6” were originally assigned.

### Intra-Store Processing

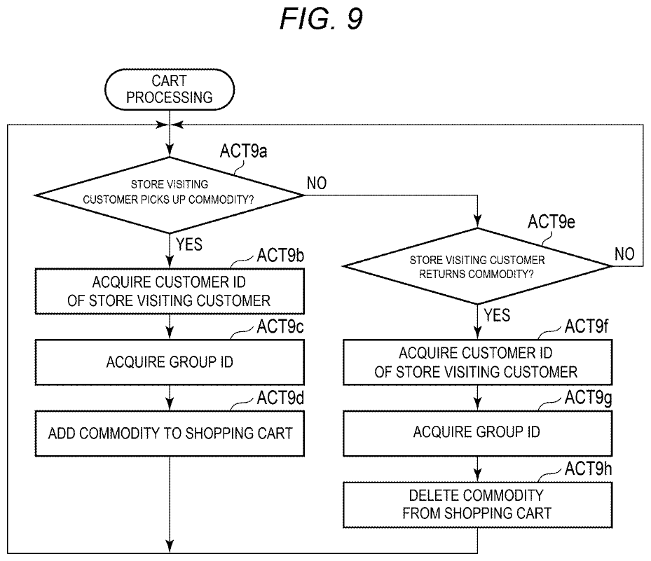

FIG. 9 is a flowchart illustrating the intra-store processing. The intra-store processing is processing for updating the content of the “shopping cart” of the group list according to actions of store visiting customers taking out commodities from and returning the commodities to the display shelves. The intra-store processing is performed by the store management device 100. The control unit 101 executes the intra-store processing according to the control program and the control data stored in the storing unit 102. The intra-store processing is repeatedly executed while the system is operating.

In ACT 9a, the control 101 acquires a tracking result of the store visiting customer tracking function and determines whether a commodity has been detected to be taken out from a display shelf. If take-out of a commodity from a display shelf is detected, the control unit 101 shifts to ACT 9b. On the other hand, if take-out of a commodity from a display shelf is not detected, the control unit 101 shifts to ACT 9e.

In ACT 9b, the control unit 101 acquires, from the store visiting customer tracking function, a customer ID of a store visiting customer who takes out the commodity from the commodity shelf, identification information of the taken-out commodity, and the number of items of the taken-out commodity and shifts to ACT 9c. In ACT 9c, the control unit 101 refers to the store visiting customer list, acquires a group ID correlated with the customer ID acquired in ACT 9b, and shifts to ACT 9d.

In ACT 9d, the control unit 101 records, in the group list, the information concerning the commodity (the identification information of the taken-out commodity and the number of items of the take-out commodity) acquired in ACT 9b in the column of the “shopping cart” correlated with the group ID acquired in ACT 9c and shifts to ACT 9a.

In ACT 9e, the control unit 101 acquires a tracking result of the store visiting customer tracking function and determines whether return of the commodity to the display shelf is detected. If return of the commodity to the display shelf is detected, the control unit 101 shifts to ACT 9f. On the other hand, if return of the commodity to the display shelf is not detected, the control unit 101 shifts to ACT 9a.

In ACT 9f, the control unit 101 acquires, from the store visiting customer tracking function, a customer ID of a customer who returns the commodity to the commodity shelf, identification information of the returned commodity, and the number of items of the returned commodity and shifts to ACT 9g. In ACT 9g, the control unit 101 refers to the store visiting customer list, acquires a group ID correlated with the customer ID acquired in ACT 9f, and shifts to ACT 9h.

In ACT 9h, the control unit 101 deletes, in the group list, the information concerning the commodity (the identification information of the returned commodity and the number of items of the returned commodity) acquired in ACT 9f from the column of “shopping cart” correlated with the group ID acquired in ACT 9g and shifts to ACT 9a.

### Settlement Processing

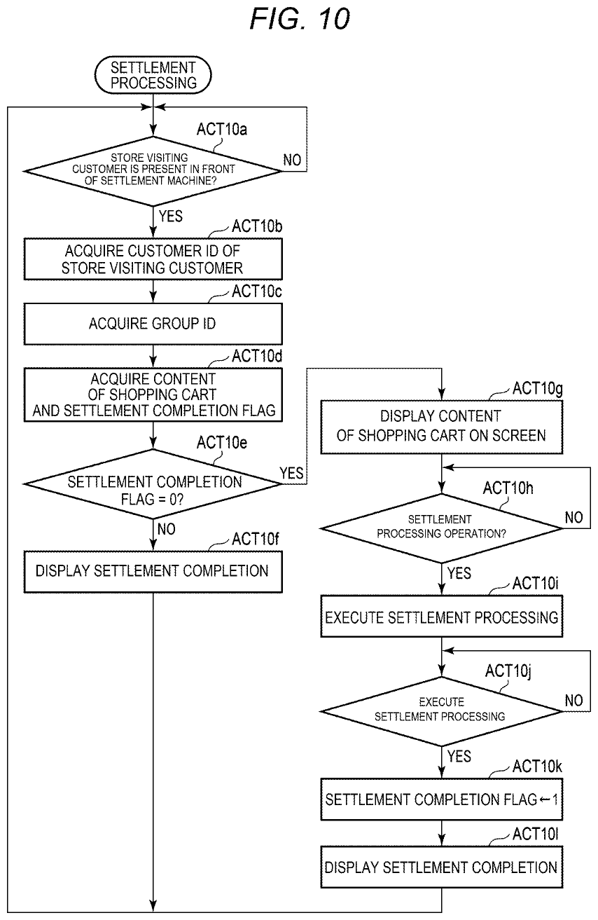

FIG. 10 is a flowchart illustrating the settlement processing. The settlement processing is processing for receiving settlement concerning commodities in the “shopping cart” of the group list from the person in charge of settlement. The settlement processing is performed by the store management device 100. The control unit 101 executes the settlement processing according to the control program and the control data stored in the storing unit 102. The settlement processing is repeatedly executed while the system is operating.

In ACT 10a, the control unit 101 determines, based on video data captured by the camera 106 and operation on the touch panel 104, that a store visiting customer is present in front of the store management device 100. The control unit 101 may determine, according to the position of a store visiting customer detected by the store visiting customer tracking function, the presence of the store visiting customer present in front of the store management device 100.

In response to determining that a store visiting customer is present in front of the store management device 100, the control unit 101 shifts to ACT 10b. On the other hand, if a store visiting customer is absent (not detected), the control unit 101 shifts to ACT 10a again and monitors arrival of a store visiting customer. In ACT 10b, the control unit 101 acquires, based on a tracking result of the store visiting customer tracking function, a customer ID of the store visiting customer present in front of the store management device 100 and shifts to ACT 10c.

In ACT 10c, the control unit 101 refers to the store visiting customer list, acquires a group ID correlated with the customer ID acquired in ACT 10b, and shifts to ACT 10d.

In ACT 10d, the control unit 101 acquires, in the group list, a value set in the column of “settlement completion flag” correlated with the group ID acquired in ACT 10c and shifts to ACT 10e.

In ACT 10e, the control unit 101 determines whether a value set in the column of “settlement completion flag” acquired in ACT 10 is “0”, that is, settlement is not completed. If “0” is set, that is, settlement is not completed, the control unit 101 shifts to ACT 10g. On the other hand, if “1” is set, that is, settlement is completed, the control unit 101 shifts to ACT 10f.

In ACT 10f, the control unit 101 performs display for informing settlement completion such as “Accounting is completed. Thank you for using out store.” on the display 103 and shifts to ACT 10a.

In ACT 10g, the control unit 101 displays, on the display 103, a content set in the column of “shopping cart” correlated with the group ID acquired in ACT 10c, that is, a list of commodity names and the numbers of items of commodities that a store visiting customer in the group are about to purchase in the group list and indication such as “Please confirm the commodities that you intend to purchase” and shifts to ACT 10h. Consequently, the store visiting customer can confirm the commodities to be settled.

In ACT 10h, the control unit 101 monitors operation on the touch panel 104 and determines whether operation indicating intention of purchase, that is, button operation indicating intention of executing the settlement processing is performed. If detecting the button operation for settlement execution, the control unit 101 shifts to ACT 10i. On the other hand, if not detecting the operation, in ACT 10h, the control unit 101 stands by for the button operation.

In ACT 10i, the control unit 101 performs, on the display 103, display for requesting that the store visiting customer perform a settlement procedure, receives settlement through the card reader 105, and shifts to ACT 10j. The settlement through the card reader 105 can be realized by a well-known technique using a credit card, a debit card, a point card, electronic money, or the like.

In ACT 10j, the control unit 101 determines whether the settlement through the card reader 105 is completed. If determining that the settlement is completed, the control unit 101 shifts to ACT 10k. On the other hand, if determining that the settlement is not completed, the control unit 101 shifts to ACT 10j and continues to monitor completion of settlement including repetition of settlement.

In ACT 10k, the control unit 101 sets, in the group list, “1” indicating settlement completion in the column of “settlement completion flag” correlated with the group ID acquired in ACT 10c, clears and empties the content of the “shopping cart”, and shifts to ACT 10l.

In ACT 10l, the control unit 101 performs display for informing the settlement completion such as “Thank you for using our store.” on the display 103, controls the printer 107 to print a receipt for the purchased commodities, and shifts to ACT 10a.

### Store Leaving Processing

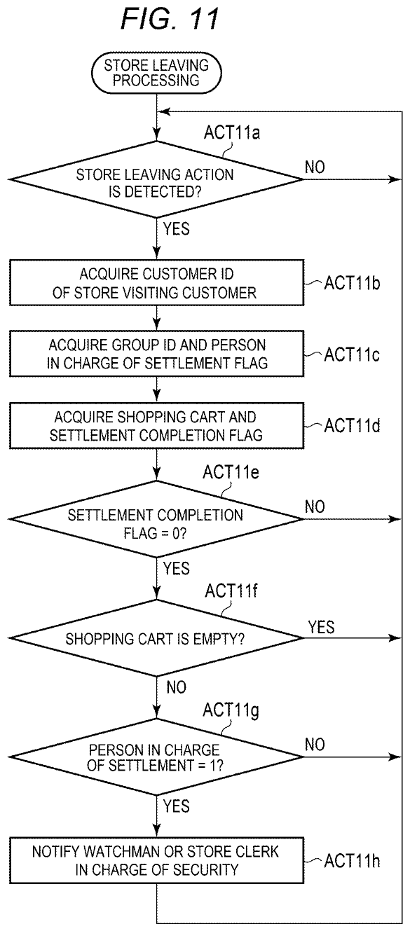

FIG. 11 is a flowchart illustrating the store leaving processing. The store leaving processing is processing for notifying settlement omission to a person in charge of settlement of a group that does not complete settlement among store visiting customers taking a store leaving action, that is, store visiting customer about to leave the store. The store management device 100 performs the store leaving processing in cooperation with the gate device 300. The control unit 101 executes the store leaving processing according to the control program and the control data stored in the storing unit 102. The store leaving processing is repeatedly executed while the system is operating.

In ACT 11a, the control unit 101 determines, based on a notification from the gate device 300, whether a store visiting customer about to leave the store is present. Specifically, the control unit 301 of the gate device 300 determines, based on video data captured by the camera 303 and a detection result by the sensor 304, that a store visiting customer enters (or is about to enter) the gate 305.

If determining that a store visiting customer about to leave the store is present, the control unit 301 notifies the store management device 100 to this effect through the communication interface 307. The control unit 101, which receives this notification, shifts to ACT 11b. On the other hand, if a notification is not received (a store visiting customer about to leave the store is not detected), the control unit 101 shifts to ACT 11a again and monitors a store visiting customer about to leave the store (stands by for a notification from the gate device 300).

In ACT 11b, the control unit 101 acquires, based on a tracking result of the store visiting customer tracking function, a customer ID of the store visiting customer about to leave the store (for example, a store visiting customer present in the gate 305) and shifts to ACT 11c.

In ACT 11c, the control unit 101 refers to the store visiting customer list, acquires a group ID and a person in charge of settlement flag correlated with the customer ID acquired in ACT 11b, and shifts to ACT 11d. In ACT 11d, the control unit 101 acquires, in the group list, content of the “shopping cart” correlated with the group ID acquired in ACT 11c and a value set in the column of the “settlement completion flag” and shifts to ACT 11e.

In ACT 11e, the control unit 101 determines whether the value set in the column of the “settlement completion flag” acquired in ACT 11d is “0”, that is, settlement is not completed. If “0” is set, that is, settlement is not completed, the control unit 101 shifts to ACT 11f. On the other hand, if “1” is set, that is, settlement is completed, the control unit 101 shifts to ACT 11a. That is, the control unit 101 prepares for, without preventing the store visiting customer from passing through the gate, gate approach of the next store visiting customer.

In ACT 11f, the control unit 101 determines whether the content of the “shopping cart” acquired in ACT 11d is empty. If the content of the “shopping cart” is not empty, the control unit 101 shifts to ACT 11g. On the other hand, if the content of the “shopping cart” is empty, the control unit 101 shifts to ACT 11a. That is, since the settlement is not completed for the store visiting customer but the store visiting customer does not take out a commodity, the control unit 101 prepares for, without preventing the store visiting customer from passing through the gate, gate approach of the next store visiting customer.

In ACT 11g, the control unit 101 determines whether the value of the person in charge of settlement flag acquired in ACT 11c is “1”, that is, whether the store visiting customer is a person in charge of settlement. If “1” is set, that is, the store visiting customer is a person in charge of settlement, the control unit 101 shifts to ACT 11h. On the other hand, if “0” is set, that is, the store visiting customer is not a person in charge of settlement, the control unit 101 shifts to ACT 11a. That is, the control unit 101 prepares for, without preventing the store visiting customer from passing through the gate, gate approach of the next store visiting customer.

In ACT 11h, the control unit 101 instructs the gate device 300 (the control unit 301) to operate the alarm 306, notifies a watchman or a store clerk in charge of security, and shifts to ACT 11a. According to the operation of the alarm 306, the store visiting customer about to pass through the gate is urged to notice settlement omission. The watchman or the store clerk in charge of security notices, according to the notification, the presence of the store visiting customer who omits to do settlement.

In ACT 11h, the control unit 101 may give an instruction to the gate device 300 through the network NW in addition to the alarm 306, for example, to close the gate, and physically prevent passage of the store visiting customer.

In ACT 11h, the control unit 101 may acquire, via the network NW, video data captured by the camera 303 provided in the gate device 300 and record the video data in the storing unit 102.

If the store visiting customer tracking function performs face recognition of the store visiting customer at the time of store entry, the control unit 101 may once record a video of the face recognized at the time of store entry in the storing unit 102, erase the video according to store leaving, and, if shifting to ACT 11h, record the store visiting customer in the storing unit 102 as a store leaving person who does not complete settlement.

### SUMMARY

As explained above, in the store management device 100 having the configuration explained above, the video data captured by the network cameras Ca-1 to Ca-n and the detection results of the sensors Sn-1 to Sn-m are acquired through the communication interface 108. A store visiting customer is identified and intra-store actions of the store visiting customer is monitored and tracked based on these kinds of information. A plurality of store visiting customers visiting the store as a group are grouped. Commodities picked up by the plurality of store visiting customers from the display shelves are collectively settled for each of groups.

Therefore, with the store management device 100 having the configuration explained above, one store visiting customer can collectively perform settlement for a plurality of store visiting customers visiting the store as a family or friends while the plurality of store visiting customers respectively hold commodities even if the plurality of store visiting customers do not use one shopping basket. Accordingly, there is an advantage that the store visiting customers can save time for respectively performing settlement. For the store, there is an advantage that congestion in a settlement terminal can be suppressed and the number of settlement terminals to be set can be reduced.

In the store management device 100 having the configuration explained above, at least one of a grouped store visiting customers is set as a person in charge of settlement. A store leaving action of the person in charge of settlement is determined based on information acquired through the communication interface 108. If the person in charge of settlement performs the store leaving action and settlement for a group to which the person in charge of settlement belongs is not completed, unsettlement is informed.

Therefore, with the store management device 100 having the configuration explained above, shoplifting can be suppressed by informing of the unsettlement. If a plurality of people visit the store as a group, even before settlement completion, people other than the person in charge of settlement can freely leave the store. Accordingly, it is possible to suppress the store from being congested by store visiting customers waiting for completion of group settlement.

In the store management device 100 having the configuration explained above, if a store visiting customer takes a store leaving action without completing settlement, video data of the person in charge of settlement is recorded. Therefore, an effect of suppressing shoplifting can be expected.

The several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

For example, in the embodiment explained above, presentation of information for specifying an individual is not requested in store entry. However, apart from this, the information can be collated with preregistered information and applied to a system of a store that a customer enters. As the preregistered information, a member card (magnetic data, a barcode, a noncontact IC card, or the like) prepared in advance, a face photograph, organism inherent information or biometric such as a fingerprint or a vein, a terminal input of a member number and a password, and the like are conceivable. These kinds of information are acquired by a reception device (mounted with a reader terminal and a camera) set near the entrance and input to the control unit 101 via the network NW and the communication interface 108. The store management device 100 performs personal authentication based on the input information and the store visiting customer tracking functions tracks intra-store actions of a store visiting customer.

What is claimed is:

1. A store management system comprising:
an interface configured to facilitate acquiring information regarding a plurality of customers who enter a store; and
a processor configured to:
identify each customer of the plurality of customers based on the information acquired through the interface;
group a subset of the plurality of customers into a customer group based on the information; and
settle a single commodity list of commodities intended to be purchased by the customer group in a single settlement transaction.

2. The store management system of claim 1, wherein the processor is configured to:
set at least one customer of the subset of the plurality of customers as a person in charge of settlement for the customer group;
determine that the person in charge of settlement is attempting to leave the store prior to settlement being completed for the customer group; and
provide an alert in response to the person in charge of settlement attempting to leave the store prior to settlement being completed for the customer group.

3. The store management system of claim 2, wherein the alert is provided to an employee of the store.

4. The store management system of claim 2, wherein the alert includes activating an alarm.

5. The store management system of claim 2, further comprising a gate configured to be positioned proximate an exit of the store, wherein the alert includes closing the gate to prevent the person in charge of settlement from leaving the store.

6. The store management system of claim 2, wherein the processor is configured to not provide the alert in response to another person of the subset of the plurality of customers associated with the customer group that is not the person in charge of settlement attempting to leave the store prior to settlement being completed.

7. The store management system of claim 1, further comprising a storage device that stores video data, wherein the processor is configured to:
set at least one customer of the subset of the plurality of customers as a person in charge of settlement for the customer group;
determine that the person in charge of settlement is attempting to leave the store prior to settlement being completed for the customer group; and
record the video data of the person in charge of settlement attempting to leave the store in response to settlement not being completed for the customer group.

8. The store management system of claim 1, further comprising:
a plurality of sensors positionable about the store to facilitate monitoring removal of commodities from display units and shelves within the store; and
a plurality of cameras positionable about the store to facilitate monitoring the plurality of customers within the store;
wherein the processor is configured to:
track the plurality of customers and the commodities selected thereby via the plurality of sensors and the plurality of cameras; and
aggregate the commodities selected by the subset of the plurality of customers associated with the customer group into the single commodity list irrespective of the commodities being or not being placed in a common shopping cart or a common shopping basket.

9. The store management system of claim 1, wherein the processing circuit is configured to:
receive a first indication regarding which customers of the plurality of customers are associated with the customer group from the interface; and
receive a second indication regarding which customer of the subset of the plurality of customers associated with the customer group is a person in charge of settlement.

10. A storage management system comprising:
an entry terminal configured to be positioned proximate an entry of a store, the entry terminal configured to facilitate acquiring information reading a plurality of customers who enter the store;
a plurality of sensors configured to be positioned about the store to monitor removal of commodities from display units and shelves within the store;
a plurality of cameras configured to be positioned about the store to monitor the plurality of customers within the store;
a gate device configured to be positioned proximate an exit of the store; and
a store management device configured to:
identify each of the plurality of customers based on the information acquired by the entry terminal;
receive a first indication from the entry terminal that a subset of the plurality of customers is associated with a customer group;
receive a second indication from the entry terminal regarding which customer of the subset of the plurality of customers associated with the customer group is a person in charge of settlement for the customer group;
track the plurality of customers and the commodities selected thereby via the plurality of sensors and the plurality of cameras;
aggregate the commodities selected by the subset of the plurality of customers associated with the customer group into a single commodity list; and
settle the single commodity list of the customer group in a single settlement transaction with the person in charge of settlement.

11. The store management system of claim 10, wherein the store management device is configured to:
determine that the person in charge of settlement is attempting to leave the store through the gate device prior to settlement being completed for the customer group; and
provide an alert in response to the person in charge of settlement attempting to leave the store prior to settlement being completed for the customer group.

12. The store management system of claim 11, wherein the alert is provided to an employee of the store.

13. The store management system of claim 11, wherein the alert includes activating an alarm.

14. The store management system of claim 13, wherein the alarm is integrated into the gate device.

15. The store management system of claim 11, wherein the gate device includes a gate, and wherein the alert includes closing the gate to prevent the person in charge of settlement from leaving the store.

16. The store management system of claim 11, wherein the processor is configured to not provide the alert in response to another person of the subset of the plurality of customers associated with the customer group that is not the person in charge of settlement attempting to leave the store prior to settlement being completed.

17. The store management system of claim 10, wherein the store management device includes a storage device that stores video data, and wherein the store management device is configured to:
determine that the person in charge of settlement is attempting to leave the store prior to settlement being completed for the customer group; and
record the video data of the person in charge of settlement attempting to leave the store in response to settlement not being completed for the customer group.

18. A store management method comprising:
acquiring, through an interface, information concerning customers who enter a store;
identifying, by a processor, each of the customers based on the information;
grouping, by the processor, a subset of the customers into a customer group based on the information; and
settling, by the processor, commodities intended to be purchased by the customer group.

19. The store management method of claim 18, further comprising:
receiving, by the processor, a first indication from the interface regarding which of the customers are associated with the customer group; and
receiving, by the processor, a second indication from the interface regarding which of the subset of customers associated with the customer group is a person in charge of settlement.

20. The store management method of claim 18, further comprising:
tracking, by the processor, the customers and the commodities selected thereby;
aggregating, by the processor, the commodities selected by the subset of the customers associated with the customer group into a single commodity list.
